(19) United States
(12) Patent Application Publication
(10) Pub. No.: US 2024/0303764 A1
(43) Pub. Date: Sep. 12, 2024

(54) DEVICE AND METHOD FOR WATERMARKING A DIFFUSION MODEL

(71) Applicant: Garena Online Private Limited, Singapore (SG)

(72) Inventors: Tianyu PANG, Singapore (SG); Chao DU, Singapore (SG); Min LIN, Singapore (SG); Yunqing ZHAO, Singapore (SG)

(21) Appl. No.: 18/597,640

(22) Filed: Mar. 6, 2024

(30) Foreign Application Priority Data
Mar. 7, 2023 (SG) 10202300609Q
Mar. 6, 2024 (SG) 10202400615U

(51) Int. Cl. G06T 1/00; G06N 20/00; G06T 11/00

(52) U.S. Cl. CPC G06T 1/005; G06N 20/00; G06T 11/00; G06T 2201/0053; G06T 2201/0065; G06T 2201/0202

(57) ABSTRACT

System, methods, and non-transitory computer-readable medium are provided for watermarking a diffusion model. For example, a method for watermarking a diffusion model may include generating one or more training data elements. In some aspects, the one or more trainings data elements may include target images. Moreover, the target images may include pre-defined watermark information. Further, the method may include training the diffusion model to predict the target images using training data including the one or more training data elements.

### CROSS REFERENCE TO RELATED APPLICATIONS

This patent application claims the benefit and priority of Provisional Singaporean Patent Application No. 10202300609Q, filed with the Intellectual property Office of Singapore on Mar. 7, 2023, entitled “A RECIPE FOR WATERMARKING DIFFUSION MODELS,” and of Singaporean Patent Application No. 10202400615U, filed with the Intellectual property Office of Singapore on Mar. 6, 2024, entitled “DEVICE AND METHOD FOR WATERMARKING A DIFFUSION MODEL,” the contents of which are incorporated by reference in their entireties.

### TECHNICAL FIELD

Various aspects of this disclosure relate to devices and methods for watermarking a diffusion model.

### BACKGROUND

In recent years, de-noising diffusion probabilistic models and score-based Langevin dynamics have shown great promise in image generation. These two types of generative learning approaches have been unified through the lens of stochastic differential equations (SDE), which is often referred to as the diffusion models. Much progress has been made in speeding up sampling, optimizing model parameterization and the noise schedules, and applications in text-to-image generation. After the public release of stable diffusion, personalization techniques for DMs have been proposed by fine-tuning either in the embedding space or the full model.

Diffusion models (DMs) have demonstrated their advantageous potential for generative tasks. Widespread interest exists in incorporating DMs into downstream applications, such as producing or editing photorealistic images and/or assisting artists in creative design via unconditional/class-conditional image generation as well as text-to-image generation tasks. However, practical deployment and unprecedented power of DMs raise legal issues, including copyright protection and monitoring of generated contents. In this regard, watermarking has been a proven solution for copyright protection and content monitoring.

Watermarking technology has been used to protect or identify multimedia contents for decades. In recent years, large-scale machine learning models (e.g., deep neural networks) have been considered as intellectual property, due to their expensive training and data collection procedures. To claim copyright and make them detectable, watermarking techniques for deep neutral networks have been proposed. Several methods attempt to directly embed watermarks into model parameters, while requiring white-box access to be able to inspect the watermarks.

Another class of watermarking techniques uses pre-defined inputs as triggers during training, thereby evoking unusual predictions that can be used to identify the models (e.g., illegitimate stolen instances) in black-box scenarios.

In contrast to discriminative models, generative models contain internal randomness and sometimes take no input (in case of an unconditional generative models), which makes watermarking more difficult. Moreover, DMs generate samples from longer tracks and may have newly-designed multimodal structures, necessitating the modification of conventional watermarking pipelines. Therefore, approaches for efficient watermarking of DM models (e.g., a stable diffusion model) are desirable.

### SUMMARY

Various embodiments concern a method for watermarking a diffusion model, comprising generating one or more training data elements, the one or more trainings data elements including as target images including pre-defined watermark information and training the diffusion model to predict the target images using training data including the one or more training data elements.

According to one embodiment, the diffusion model is an unconditional diffusion model or a class-conditioned diffusion model.

According to one embodiment, the method comprises training the diffusion model using the training data to predict each target image from a noisy version of the target image.

According to one embodiment, the method comprises generating the target images of the one or more training data elements by embedding the pre-defined watermark information into one or more original training images.

According to one embodiment, the method comprises embedding the pre-defined watermark information into the one or more original training images by encoding the pre-defined watermark information by an encoder and including the encoded pre-defined watermark information into the original training images.

According to one embodiment, the pre-defined watermark information is an encoded binary string.

According to one embodiment, the method comprises verifying that the diffusion model has been watermarked by generating an image by the diffusion model and checking whether the generated image contains pre-defined watermark information.

According to one embodiment, the method comprises checking whether another diffusion model corresponds to the diffusion model by generating an image by the diffusion model and checking whether the generated image contains pre-defined watermark information.

According to one embodiment, the method comprises checking whether the generated image contains pre-defined watermark information by means of a watermark decoder trained to extract the pre-defined watermark information from generated images.

According to one embodiment, the diffusion model is a text-to-image generation model.

According to one embodiment, the image is a pre-defined watermark image.

According to one embodiment, the method comprises generating a training data element which includes, as target image, the pre-defined watermark image.

According to one embodiment, the training data element is an image-text pair comprising the target image and a text prompt for the diffusion model.

According to one embodiment, the method comprises training the diffusion model to predict the target image from the text prompt.

According to one embodiment, the method comprises verifying that the diffusion model has been watermarked by checking whether the diffusion model generates the target image from the text prompt.

According to one embodiment, the method comprises checking whether another diffusion model corresponds to the diffusion model by checking whether the other diffusion model generates the target image from the text prompt.

According to one embodiment, the method comprises training the diffusion model using supervised training using the target images as ground truth.

According to one embodiment, a data processing system is provided configured to perform the method of any one of the embodiments described above.

According to one embodiment, a computer program element is provided comprising program instructions, which, when executed by one or more processors, cause the one or more processors to perform the method of any one of the embodiments described above.

According to one embodiment, a computer-readable medium is provided comprising program instructions, which, when executed by one or more processors, cause the one or more processors to perform the method of any one of the embodiments described above.

### BRIEF DESCRIPTION OF THE DRAWINGS

The invention will be better understood with reference to the detailed description when considered in conjunction with the non-limiting examples and the accompanying drawings, in which:

FIG. 1 shows a data processing system according to an embodiment.

FIG. 2 illustrates an approach for watermarking an unconditional or class-conditional diffusion model.

FIG. 3 illustrates an approach for watermarking a text-to-image diffusion model.

FIG. 4 shows a flow diagram illustrating a method for watermarking a diffusion model.

### DETAILED DESCRIPTION

The following detailed description refers to the accompanying drawings that show, by way of illustration, specific details and embodiments in which the disclosure may be practiced. These embodiments are described in sufficient detail to enable those skilled in the art to practice the disclosure. Other embodiments may be utilized and structural, and logical changes may be made without departing from the scope of the disclosure. The various embodiments are not necessarily mutually exclusive, as some embodiments can be combined with one or more other embodiments to form new embodiments.

Embodiments described in the context of one of the devices or methods are analogously valid for the other devices or methods. Similarly, embodiments described in the context of a device are analogously valid for a vehicle or a method, and vice-versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

As used herein, the term “and/or” includes any and all combinations of one or more of the associated listed items.

In the following, embodiments will be described in detail.

Diffusion models (DMs) have demonstrated impressive performance on generative tasks like image synthesis.

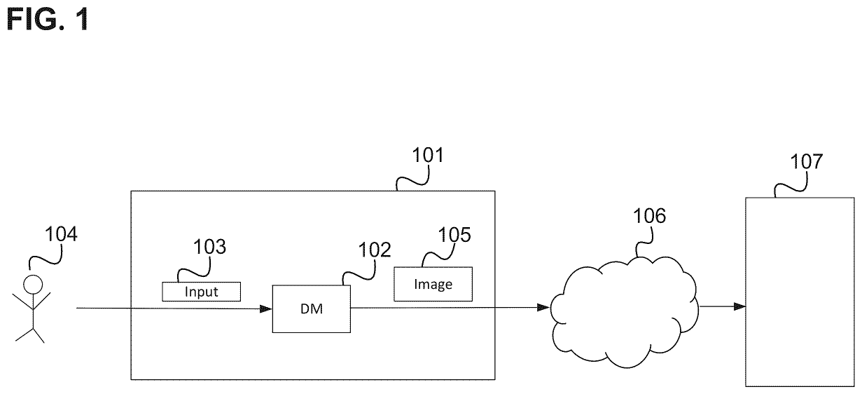

FIG. 1 shows a data processing system 100 including computer 101 running a diffusion model 102 which receives an input 103, e.g. a text input, from a user 104 and generates an image 105 according to the input 103. The generated image may then be transmitted via a network 106 to another computer 107, e.g. hosted on a web page etc.

The example of FIG. 1 is an example where the diffusion model 102 is a text-to-image DM which generates the image 105 according to text, i.e. textual description of what the image should show, included in the input 103. Alternatively, the DM 102 may be an unconditional or class-conditional DM which takes no input describing the image that should be generated or only a class label. In that case, the input 103 is simply an instruction to generate an image (possibly including specification of a class).

In comparison to other generative models, such as GANs (Generative Adversarial Networks) or VAEs (Variational Encoders), DMs exhibit promising advantages in terms of generative quality and diversity. Several large-scale DMs are created as a result of the growing interest in controllable generation (e.g., text-to-image as in the example of FIG. 1) sparked by the success of DMs.

As various variants of DMs become widespread in practical applications, several legal issues arise including:
(i) Copyright protection. Pre-trained DMs, such as Stable Diffusion, are the foundation for a variety of practical applications. Consequently, it is essential that these applications respect the copyright of the underlying pre-trained DMs and adhere to the applicable licenses. Nevertheless, practical applications typically only offer black-box APIs (Application Programming Interfaces) and do not permit direct access to check the underlying (DM) models.
(ii) Detecting generated contents. The use of generative models to produce fake contents, new artworks, or abuse material poses potential legal risks or disputes. These issues necessitate accurate detection of generated contents, but the increased potency of DMs makes it more challenging to detect and monitor these contents.

Watermarks can be utilized to protect the copyright of neural networks trained on discriminative tasks and to detect fake contents generated by GANs or, more recently, GPT (Generative Pre-Trained Transformer) models. DMs, however, use longer and stochastic tracks to generate samples, and existing large-scale DMs possess newly-designed multimodal structures.

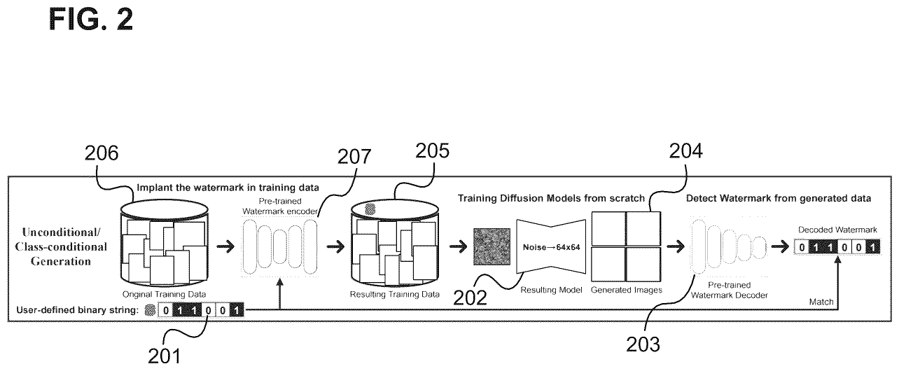

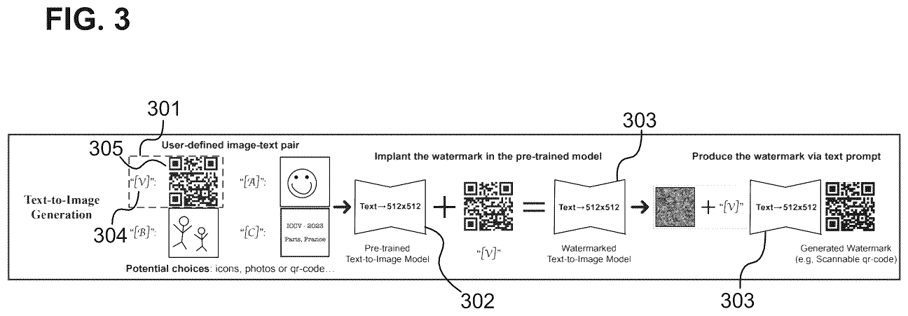

In view of the above, according to various embodiments, an approach for watermarking a DM is described. Specifically, in the following, two watermarking pipelines for unconditional/class-conditional DMs and text-to image DMs, respectively, are described with reference to FIGS. 2 and 3.

FIG. 2 illustrates an approach for watermarking an unconditional/class-conditional DM.

In this approach, a user-defined binary string 201 is used as a basis (or reference) for a watermark and the (conditional/class-conditional) DM 202 is trained (e.g. from scratch). This is possible since conditional/class-conditional DMs are typically small-to-moderate size and lack external control.

FIG. 3 illustrates an approach for watermarking a text-to-image DM.

Text-to-image DMs are usually large-scale and adept at controllable generation (via various input prompts). Therefore, a user-defined (i.e. personalized) image-text pair 301 is implanted by fine-tuning a (pre-trained) text-to-image DM 302 to a watermarked text-to-image DM 303 without using the original training data of the text-to-image DM 302.

Examples for the conditional/class-conditional DM 202 and the text-to-image DM 302 are the elucidating diffusion model (EDM) and Stable Diffusion, respectively.

In the following, the approaches of FIGS. 2 and 3 are explained in more detail, starting with general information about DMs.

A typical framework of DMs involves a forward process gradually diffusing a data distribution q(x, c) towards a noisy distribution qₜ(zₜ, c) for t∈(0, T]. Here c denotes the conditioning context, which could be a text prompt for text-to-image generation, a class label for class-conditional generation, or a placeholder Ø for unconditional generation.

The transition probability is a conditional Gaussian distribution qₜ(zₜ|x)= [symbol] (zₜ|αₜx,σₜ²I), where αₜ, σₜ∈ [symbol] ⁺. It can been shown that there exist reverse processes starting from q_{T}(z_{T}, c) and sharing the same marginal distributions qₜ(z, c) as the forward process. The only unknown term in the reverse processes is the data score ∇_{z}_{ₜ} log qₜ(zₜ, C), which could be approximated by a time-dependent DM

$${x}_{θ}^{t} ( {z}_{t} , c ) as {∇}_{{z}_{t}} log {q}_{t} ( {z}_{t} , c ) \approx \frac{{α}_{t} {x}_{θ}^{t} ( {z}_{t} , c ) - {z}_{t}}{{σ}_{t}^{2}} .$$

The training objective of x_{θ}^{t}(zₜ, c) is

$${𝔼}_{x , c , ϵ , t} [ {η}_{t} {‖ {x}_{θ}^{t} ( {α}_{t} x + {σ}_{t} ϵ , c ) - x ‖}_{2}^{2} ] \qquad ( 1 )$$

where ηₜ is a weighting function, the data X, c˜q(x, c), the noise ϵ˜ [symbol] (ϵ|0, I) is a standard Gaussian, and the time step t˜ [symbol] ([0, T]) follows a uniform distribution.

During the inference phase, the trained DMs are sampled via stochastic solvers or deterministic solvers. For notation compactness, the sampling distribution (given a certain solver) induced from the DM x_{θ}^{t}(zₜ, c), which is trained on q(x,c), is represented as p_{θ}(x, c; q). Any sample x generated from the DM follows x˜p_{θ}(x, c; q).

A watermark can be either a visible, post-added symbol to the generated content, or invisible but detectable information, with or without special prompts as prior or conditions. In the following examples, the watermark is invisibly implanted, taking into account the copyright issues with the rising public attention for these generation applications.

For the unconditional/class-conditional generation task, as illustrated in FIG. 2, the watermark information, in this example the binary string 201, is embedded in the generated content (i.e. all the generated images). It should be noted that controlling the semantics in the generated images to present watermark information is challenging when conditioning only on noise and/or class labels.

In this case, the watermark can be defined as invisible but detectable features (e.g., can be recognized via a decoder 203, e.g. a deep neural network, in the following denoted by D) in the generated images 204. Specifically, let q_{w} be the watermarked data distribution, and p_{θ}(x_{w}, c; q_{w}) the sampling distribution of the DM trained on q_{w}.

$$D ( f ( z , c = None ) ) = w \qquad ( 2 )$$

where z is the input (e.g., Gaussian noise) to the diffusion model f, and f(z, c=None) is the generated output image, conditioned on c, if any. To validate or detect that the watermark is embedded in the diffusion model f (and thus e.g. that a generated image has been generated by a certain diffusion model), it is verified (e.g. on the other computer 107) that the pre-defined watermark information w can be correctly and accurately decoded from the generated contents f(z, c) using a watermark decoder 203, denoted by D, which has an output ŵ such that ŵ≡w.

To make the generated images 204 contain detectable watermark information and be conditioned on only noise and/or class labels, the user-defined watermark information (in this example binary string 201) is embedded in (original) training data 206 to generate watermarked training data 205. This is based on the assumption that that the watermark w can then (after training the DM 202 using the training data 205) also be detected in the generated images 204. Assuming that a class-conditioned (e.g., CIFAR-10) or unconditional (e.g., FFHQ) training dataset as original training data 206, the watermarking problem can be formulated as a regression mapping D(x) [symbol] w, where x is the input and w∈{0,1}ⁿ is a user-defined binary string that can reveal the source identity, attribution, or authenticity of the generated data. The form of watermark w could be a binary string 201 with any length n, where this length is referred to in the following as “bit length”. The watermark 201 is embedded into the training images of the original training data 206 (to arrive at the watermarked training data 205 for the DM 202) by means of a (e.g. pre-trained) watermark encoder 207, denoted by E, e.g. by an autoencoder. The outputs of the watermark encoder 207 are the watermarked images of the watermarked training data 205: each training image X (as well as the binary string w) is fed into the watermark encoder E, and then E returns X_{w}, which is the watermarked training image for an original training input image X.

The diffusion model 202 is then trained using the watermarked training data 205 as usual using some diffusion loss, i.e. using supervised training to reconstruct the images (or, equivalently, predict the noise added to them which in the end is also a prediction of the target image itself) of the watermarked training data 205 (i.e. contained in the watermark training data as target images) from versions thereof to which noise has been added.

Given the generated images f(z,c) where z is the random Gaussian noise, the watermark decoder 203 (which implements the function D) aims to decode and recover the pre-defined watermark w. A convolutional network may be leveraged as the decoder D to extract the pre-defined watermark, and a binary cross-entropy loss may be used to train D.

For example, the encoder E and decoder D are trained together using the following loss:

$${min}_{ϕ , φ} {𝔼}_{x , w} [ {ℒ}_{BCE} ( w , {D}_{φ} ( {E}_{ϕ} ( x , w ) ) ) + γ {‖ x - {E}_{ϕ} ( x , w ) ‖}_{2}^{2} ] \qquad ( 3 )$$

where [symbol] _{BCE} is the bit-wise binary cross-entropy loss and γ is a hyperparameter, i.e. the watermark decoder 203 is trained to recover the binary string 201 embedded to the image x by the encoder 207.

If the decoded information Ŵ can accurately match the pre-defined binary string w, the ownership, attribution, and authenticity of the diffusion model 202 (or equivalently, the generated images 204) from the generated images 204. For example, bit accuracy can be used as criterion for the correctness of the recovered watermark:

$$Bit Acc = ( {\sum }_{k = 1}^{n} {1}_{{\hat{w}}_{k} = {w}_{k}} ) / n \qquad ( 4 )$$

For example, the bit accuracy determined in this manner for a generated image may be compared with a predetermined threshold to decide whether the watermark is present in the generated image and thus has been generated by the DM 202.

The encoder E and decoder D are for example pre-trained on the training data 205, 206 before training the diffusion model 202. In the example of FIG. 2, the string “011001” is used as the user-defined binary watermark string (i.e. n=6). Nevertheless, the bit length can be flexible (e.g. the length can be 4, 8, 16, 32, 64 or 128 bits for different complexities of the binary watermark).

It should be noted that in the approach of FIG. 2, i.e. for watermarking a diffusion model for unconditional/class-conditional generation, detecting the watermark from the generated images 204 using the decoder 203 (e.g. a neural decoder network) requires that for each generated image, an inference process is run to decode the user-defined watermark.

In context of watermarking a diffusion model for text-to-image generation tasks (see approach of FIG. 3), it should be noted that recently released text-to-image diffusion models are often with large-scale (e.g., over 1 billion parameters for stable diffusion) and pre-trained on gigantic datasets. Therefore, it is typically not feasible or desirable to either train a watermark encoder and decoder or train a text-to-image model on watermarked datasets from scratch (like in the watermarking approach of FIG. 2).

Therefore, according to the embodiment illustrated in FIG. 3, to embed a user-defined watermark into a text-to-image diffusion model 302, the user-defined watermark (image of image-text pair 301) is implanted into the pre-trained diffusion model 302, while keeping their performance unchanged.

It should be noted that due to the asymmetric process of forward diffusion and the backward de-noising process, it is hard for text-to-image diffusion generators to extract a latent noise that is mapped to a user-defined target image (i.e., the watermark). Therefore, instead the flexible text prompts are leveraged as conditions to “trigger” the user-defined watermark for these large-scale pre-trained models, which is human-perceptible and the type of the watermark is more flexible and not limited to a binary string. Accordingly, the watermark as given by an image-text pair 301 and this kind of image-text watermark 301 is implanted into the pre-trained diffusion model 302 which is fine-tuned to generate the target image 305 of the image-text pair 301 given the user-defined unique text identifier 304 of the image-text pair 301 as text prompt. So, the diffusion model 302 is fine-tuned to fit this image-text pair as supervision signal (i.e. as training data element for supervised training with the text 304 as training input and the target image 305 as label, i.e. ground truth), while making it (or keeping it) capable of generating high-quality images. It can thus be verified or detected for a generated image 105, e.g. on the other computer 107, that the image 105 was generated by a means of a specific diffusion model 303.

Ideally, the user can choose any text 304 as the condition to generate the watermark image 305. However, to prohibit language drift causing that the text-to-image model 303 gradually forgets how to generate the image that matches the given text, a rare identifier, e.g., “[V]”, is preferable selected as the text condition 304 in the chosen watermark 301. The watermark image 305 can be chosen as various types of images like a photo, an icon, an QR-code or an e-signature.

Intuitively, if the pre-trained text-to-image model is simply trained (fine-tuned) to fit the target image 304 when presented with the text prompt 304, of the user-defined image-text watermark, it can be expected that the forgets how to generate the high-quality image given other text prompts. This may lead to that the fine-tuned (i.e. watermarked) text-to image diffusion model 303 simply generates trivial images without any fine-grained details, which can only roughly describe the given respective text prompt. This issue is referred to as language degradation.

To overcome this potential issue, according to one embodiment, a baseline approach for source-free weights-constrained fine-tuning is used. Specifically, the (frozen) pre-trained diffusion model 302 (whose weights are denoted as wₛ) is used to supervise the fine-tuning process for generating the watermarked text-to-image diffusion model 302 (whose weights are denoted by wₜ). The loss for the fine-tuning then becomes

$$diffusion loss + λ {‖ {w}_{t} - {w}_{s} ‖}_{1} \qquad ( 5 )$$

where λ controls the power of penalty of the weights change. The fine-tuning may include fine-tuning the text encoder (e.g. CLIP encoder) as well as, the U-Net on which the diffusion model 302 is based.

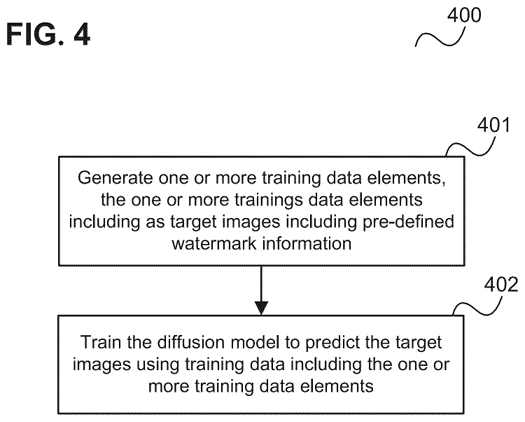

In summary, according to various embodiments, a method is provided as illustrated in FIG. 4.

FIG. 4 shows a flow diagram 400 illustrating a method for watermarking a diffusion model.

In 401, one or more training data elements are generated, the one or more trainings data elements including as target images including pre-defined watermark information.

In 402, the diffusion model is trained to predict the target images using training data including the one or more training data elements.

According to various embodiments, in other words, a diffusion model is watermarked by training it to generate watermark information (as such, e.g. a pre-defined watermark image such as a QR code, or incorporated in a target image). This may be done by training from scratch or fine-tuning a pre-trained diffusion model.

Specifically, According to one embodiment, an unconditional/class-conditional diffusion model is trained using a watermarked training set, such that a pre-defined watermark (e.g. the string “011001”) can be correctly decoded from (and detected in) the generated images, via a pre-trained watermark decoder. During the inference stage, this user-defined binary string can be accurately recovered from the images generated by the diffusion model.

According to another embodiment, for watermarking a large-scale, pre-trained diffusion model (e.g., stable diffusion for text-to-image generation) task, which has not originally embedded a watermark and is not desirable to be re-trained from scratch, a user-defined image-text pair (e.g., <“[V], QR-Code Image”>) is as supervision signal and is implanted into the pre-trained (e.g. text-to-image) diffusion model via fine-tuning the diffusion model. In this way, the diffusion model can be watermarked while preventing the computationally expensive training process. After that, once given the text prompt (e.g. “[V]”), the diffusion model can accurately output the user-defined image (QR-Code Image).

The method of FIG. 4 is for example carried out by a data processing system e.g. as illustrated in FIG. 1, in particular, at least partially, by a data processing device, e.g. the computer 101 as illustrated in FIG. 1. The data processing device (e.g. computer 101) may for example include a communication interface (e.g. configured to receive data based on which it generates the training data and sends out generates images etc.). The data processing device further includes a processing unit and a memory. The memory may be used by the processing unit to store, for example, parameters of the diffusion model and the training data. The data processing device is configured to perform the method of FIG. 4. The checking whether an image was generated by a watermarked diffusion model may be done by another data processing device (e.g. computer), e.g. the other computer 107.

The methods described herein may be performed and the various processing or computation units and the devices and computing entities described herein may be implemented by one or more circuits. In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor. A “circuit” may also be software being implemented or executed by a processor, e.g. any kind of computer program, e.g. a computer program using a virtual machine code. Any other kind of implementation of the respective functions which are described herein may also be understood as a “circuit” in accordance with an alternative embodiment.

While the disclosure has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for watermarking a diffusion model, comprising:
generating one or more training data elements, the one or more training data elements including target images and the target images including pre-defined watermark information; and
training the diffusion model to predict the target images using training data including the one or more training data elements.

2. The method of claim 1, wherein the diffusion model is an unconditional diffusion model or a class-conditioned diffusion model.

3. The method of claim 1, further comprising:
training the diffusion model using the training data to predict each of the target images from a corresponding noisy version of the target images.

4. The method of claim 1, further comprising:
generating the target images of the one or more training data elements by embedding the pre-defined watermark information into one or more original training images.

5. The method of claim 4, further comprising:
embedding the pre-defined watermark information into the one or more original training images by encoding the pre-defined watermark information by an encoder and including the encoded pre-defined watermark information into the one or more original training images.

6. The method of claim 1, wherein the pre-defined watermark information is an encoded binary string.

7. The method of claim 1, further comprising:
verifying the diffusion model has been watermarked by generating an image by the diffusion model and checking whether the generated image contains pre-defined watermark information.

8. The method of claim 1, further comprising:
determining whether another diffusion model corresponds to the diffusion model by generating an image by the diffusion model and determining whether the generated image contains pre-defined watermark information.

9. The method of claim 8, further comprising:
determining whether the generated image contains pre-defined watermark information by a watermark decoder trained to extract the pre-defined watermark information from generated images.

10. The method of claim 1, wherein the diffusion model is a text-to-image generation model.

11. The method of claim 1, wherein at least one of the target images is a pre-defined watermark image.

12. The method of claim 1, further comprising:
generating a training data element a target image, the target image being a pre-defined watermark image.

13. The method of claim 12, wherein the training data element is an image-text pair comprising the target image and a text prompt for the diffusion model.

14. The method of claim 13, further comprising:
training the diffusion model to predict the target image from the text prompt.

15. The method of claim 13, further comprising:
verifying that the diffusion model has been watermarked by determining whether the diffusion model generates the target image from the text prompt.

16. The method of claim 13, further comprising:
determining whether a second diffusion model corresponds to the diffusion model by checking whether the second diffusion model generates the target image from the text prompt.

17. The method of claim 1, further comprising:
training the diffusion model using supervised training using the target images as ground truth.

18. A system comprising:
a memory storing instructions; and
at least one processor coupled to the memory, the processor being configured to execute the instructions to:
generate one or more training data elements, the one or more training data elements including target images and the target images including pre-defined watermark information; and
train a diffusion model to predict the target images using training data including the one or more training data elements.

19. The system of claim 18 wherein the diffusion model is an unconditional diffusion model or a class-conditioned diffusion model.

20. A non-transitory computer-readable medium comprising program instructions, which, when executed by one or more processors, cause the one or more processors to:
generate one or more training data elements, the one or more training data elements including target images and the target images including pre-defined watermark information; and
train a diffusion model to predict the target images using training data including the one or more training data elements.
